(19) United States
(12) Patent Application Publication
(10) Pub. No.: US 2025/0223732 A1
(43) Pub. Date: Jul. 10, 2025

(54) METHOD FOR RECLAIMING FIBERS FROM TEXTILES WASTE

(71) Applicant: BROMINE COMPOUNDS LTD., Beer-Sheva (IL)

(72) Inventors: Ella RAPAPORT, Moshav Shahar (IL); Iris BEN DAVID, Ashdod (IL); Revital BEN DANIEL, Modiin Maccabim Reut (IL); Gershon MIASKOVSKI, Beer Sheva (IL); Eyal EDEN, Shoham (IL); Elad HAKIMI, Beer-Sheva (IL); Yuri CHERNOMORDIK, Lehavim (IL); Itzhak SHALEV, Beit Gamliel (IL); Yelena EPSHTEIN ASSOR, Beer Sheva (IL); Orel AMAR, Ofakim (IL); Yaakov RACHMILEVITCH, Beer Sheva (IL)

(21) Appl. No.: 18/852,791

(22) PCT Filed: Apr. 3, 2023
(86) PCT No.: PCT/IL2023/050349

§ 371 Date: Sep. 30, 2024

Related U.S. Application Data
(60) Provisional application No. 63/326,923, filed on Apr. 4, 2022.

(51) Int. Cl. D01G 11/00; C08J 11/16; D01G 5/00; D06B 3/10; D06M 11/13; D06M 11/155; D06M 101/06; D06M 101/32

(52) U.S. Cl. CPC D01G 11/00; C08J 11/16; D01G 5/00; D06B 3/10; D06M 11/13; D06M 11/155; C08J 2301/02; C08J 2333/04; C08J 2367/00; C08J 2375/04; C08J 2377/06; D06M 2101/06; D06M 2101/32; D10B 2201/02; D10B 2331/04

(57) ABSTRACT

A method for reclaiming fibers from a textile made of cellulose/synthetic fiber blend, comprising adding the textile to a solution comprising molten salt hydrate (MSH) and an acid catalyst to form a reaction mixture in which cellulose fibers are fibrillated and depolymerized, terminating the reaction to obtain fibrillated and depolymerized cellulose, recovering the cellulose from the re-action mixture, and recovering the synthetic fiber.

Globally, an estimated 92 million tons of textiles waste is created each year. By 2030, more than 134 million tons of textiles a year will be discarded. Worldwide, just 12% of the material used for clothing ends up being recycled. Compared to paper, glass and plastic PET bottles-which have recycling rates of 66%, 27% and 29% respectively in the US, textiles lag behind. Most recycled textiles end up as low value products such as rags and fillers making the economics of recycling untenable.

The most common fibers used in textiles are polyester and cotton. Smaller amounts are polyamide and polyolefin fibers. Each textile article is made up of thousands of tightly interlaced individual fibers. Methods used to separate the fibers invariably damage and shorten the fibers making their direct reuse in textiles difficult.

Textiles made of polyester-cotton blends are now among the most popular fabrics for use in clothing and many other textiles. The blend is usually at the fiber level. This makes them hard to separate so that they can be effectively recycled. Sorting textiles into different fibers and material types by hand is labor intensive, slow and requires a skilled workforce and does not solve the fiber blend problem. Fiber recycling technologies do exist, but they are only used on a small scale. Generally, the techniques can be separated into mechanical and chemical recycling.

Mechanical recycling, where fabrics are shredded and pulled to break them down into fibers, produces fabrics of lower quality and strength due to the shortening of the constituent fibers. The results from this kind of recycling cannot be used for producing clothing. Instead, these tend to then be “downcycled” to produce low value fiber materials such as thermal insulation and wadding.

There has been success on a smaller scale to effectively separate natural and synthetic blends, such as cotton/polyester blend, using chemical pathways. There are various enzymatic, solvent and hydrolytic methods to dissolve cellulose, polyester or both. However, scaling up these technologies to an industrial scale has proved to be technically and economically challenging. Moreover, none of these approaches leave both the cellulosic and the polyester components unaffected, nor do they provide any concepts for direct upcycling. Therefore, there exists a need for new recovery methods of blended waste textile products.

Molten Salt Hydrate (MSH) of lithium bromide (LiBr), was found to be able to dissolve bleached hardwood kraft pulp, without significant depolymerization of cellulose (Xueqin Zhang, Naiyu Xiao, Huihui Wang, Chuanfu Liu, and Xuejun Pan. Polymers, 2018, 10, 614). Cellulose was first swelled, then hydrolyzed, then dissolved in a homogenous medium of concentrated (above 50% by weight) aqueous solution. It has been postulated that the process works by breaking hydrogen bonds, increasing the hydrophilicity of cellulose and benefits from a synergetic effect of the bromine.

In U.S. Pat. No. 9,187,790B2 molten salt hydrates (MSHs), such as MSH of LiBr and MSH of CaBr₂, were used in fractionation, conversion, and saccharification of lignocellulosic biomass (plant matter such as wood pulp, corn stover and waste paper). The purpose was to obtain sugars from wood as feedstock for further fermentation processes for fuels and chemicals. Multipart separation of hemicellulose and lignin was required to obtain the desired sugars.

International patent application publication WO 2020/212616 describes a method for the preparation of micro- or nanocrystalline cellulose from virgin cellulose like cotton linter using a hydrate of zinc chloride as the molten salt (ZnCl₂ MSH). The method requires the use of an MSH free of proton acid, in particular, the use of a ZnCl₂ MSH in combination with a proton scavenger such as Zno or Zn(OH)₂ (see WO2020212616, Examples 1-4).

In CN102093484 nanocrystalline cellulose is prepared from cellulosic material such as cotton, chemical pulp or microcrystalline cellulose. The method combines preparing a suspension of the cellulosic material in a molten salt hydrate of zinc chloride and homogenizing the solution at a high speed, such as 8,000 or 12,000 rev/mins, for one to several hours. Diluted acid such as hydrochloric acid, sulfuric acid or phosphoric acid is added to ensure that the cellulose is separated out and to prevent precipitation of Zn(OH)₂.

In contrast to the lignocellulose biomass, cotton found in textiles is mostly pure cellulose. A series of preparation steps (enzymatic de-sizing, alkaline scouring, oxidative bleaching, etc.) is routinely practiced in the textile finishing industry to remove native cotton “impurities” including fats, waxes, proteins, hemicellulose, etc.

We have now found a method for MSH treatment of post-consumer textiles that results in fibrillated depolymerized cellulose-containing medium (also referred to as “dope”), from which defibrillated and depolymerized cellulose is easily recoverable. In the case of cotton/polymer blends, such as cotton/polyester (PET) blends, the cotton component moves into the liquid phase, such that the synthetic component, which remains intact, can be separated as unaffected fibers which may be reused as-is or may be melted and re-extruded into new fibers or other products, e.g. bottles. The dope may be used to produce cellulose products such as microcrystalline cellulose (MCC), cellulose variants such as hydroxyethyl cellulose (HEC), cast cellulosic films, fibers or structural elements. The present invention, therefore, provides a new cost-efficient, environmentally-friendly method for recycling cotton and various blended cotton/polymer waste textile products. Notably, the method of the invention allows separation of the undamaged polyester fibers thereby facilitating their direct reuse in textiles and other applications.

MCC is pure fibrous partially depolymerized cellulose, traditionally commercially synthesized from wood pulp. MCC can be obtained by different processes such as high pressure homogenization, enzyme mediated, steam explosion and acid hydrolysis. The latter process can be done using mineral acids such as H₂SO₄, HCl and HBr as well as ionic liquids. The role of these reagents is to hydrolyze the amorphous regions between the crystalline domains and release the microcrystalline fibrils. Major applications of MCC are in pharma, food, cosmetics and others, as binders, anticaking agents, thickeners, emulsifiers, fillers and more.

The present invention is therefore primarily directed to a method of recovery of cellulose, especially in the form of MCC, from cellulose-containing textiles, preferably waste textiles. In the case of cellulose-containing waste textiles that are cellulose/polymer blends, the present invention provides effective separation and recovery of the substantially undamaged synthetic polymer (synthetic fiber) component. By “substantially undamaged” is meant that the polymer fibers are suitable for direct reuse in textiles and in other applications.

Thus, the invention provides a method for recovering cellulose from textiles, comprising adding a cellulose-containing textile to a solution comprising MSH and acid catalyst to form a reaction mixture in cellulose which fibers are fibrillated and depolymerized, terminating the decomposition to obtain fibrillated and depolymerized cellulose, and recovering a cellulose product, such as microcrystalline cellulose, from the reaction mixture.

Hereinafter cellulose “fibrillation and depolymerization” is also named cellulose “decomposition” for the purpose of simplicity.

The decomposition of the cellulose is controlled by adjusting the pH of the reaction mixture to terminate the reaction when the optimal yield of fibrillated and depolymerized cellulose is obtained, dispersed in the reaction mixture. The cellulose product is then recovered by diluting the reaction mixture with water to obtain the cellulose product in a form separable from the liquid phase of the diluted reaction mixture. For example, the cellulose product is separated from the liquid phase of the diluted reaction mixture by filtration.

When the cellulose-containing textile is a textile made of cellulose/synthetic fibers blend, the method of the invention comprises adding the cellulose-containing textile to a solution comprising an MSH and acid catalyst to form a reaction mixture in which cellulose fibers are decomposed, terminating the decomposition of the cellulose fibers by adjusting the pH of the reaction mixture to obtain fibrillated and depolymerized cellulose, with a synthetic textile component remaining insoluble, diluting the reaction mixture with water to obtain the cellulose product in a form separable from the liquid phase of the diluted reaction mixture, separating and recovering the synthetic fiber component, and recovering the cellulose product, such as microcrystalline cellulose, from the diluted reaction mixture.

The starting material for the process of the invention can be any cellulose-containing textile material, preferably a textile waste material. The cellulose-containing textile may comprise natural, plant-based fibers such as cotton, hemp, sisal, flax, jute, ramie, bagasse or may be man-made cellulosic fiber such as regenerated cellulose, viscose, rayon, cupro, lyocell, modal, or a mixture thereof. Preferably, the cellulose-containing textile material is cotton.

The starting material for the process of the invention can be any cellulose-based material comprising both cellulose and synthetic fibers. “Synthetic fibers” means that the fibers are man-made fibers produced entirely from chemical substances. The synthetic fibers in cellulose-containing textile materials that are treated by the method of the invention can for example be polyethylene terephthalate (PET), polybutylene terephthalate (PBT), polylactic acid (PLA), polyolefins, polyamides (nylon), polyurethane (Lycra) and polyacrylonitrile (Acrylic).

Preferably, the synthetic fiber in the cellulose-containing textile material is polyethylene terephthalate (PET), herein it is also named “polyester”.

The cellulose-containing textile comprising both cellulose and synthetic fibers can be formed from blended yarns (blending performed before spinning of the yarn) or by a combination of cellulose-based and synthetic yarns that were combined in the production of the fabric or sewn together. The method of the invention is useful for recycling of any kind of cellulose-containing textile comprising both cellulose and synthetic fibers. The method of the invention is particularly advantageous when applied to textiles that are formed from cellulose/synthetic fiber blends. Cotton/polyester blend textiles are preferred since these represent the largest group of textile waste. The textile waste may originate from various sources such as used post-consumer garments, home textiles, cloths, low-grade cotton, excess from textile factories, etc.

Non-limiting examples of cellulose-containing waste textiles include blends of cotton/polyester (cotton/PET), cotton/PBT, viscose/PET, rayon/PET, modal fibers/PET, or lyocell fibers/PET. Any cellulose-based material comprising any ratio of cellulose to polyester can be treated for recovery of cellulose fibers and polyester fibers utilizing the method of the invention. Useful examples comprise blends of cellulose, e.g., cotton, viscose, or lyocell fibers, and PET at a ratio of 80:20 (cellulose: PET), 70:30, 65:45, 60:40, 55:45, and 50:50, as well as the opposite ratios of PET:cellulose, i.e. 80:20, 70:30, 65:45, 60:40, 55:45.

Additional examples of cellulose-containing waste textiles include blends with nylon (e.g. Nylon 6, 6) such as cotton/nylon, viscose/nylon, rayon/nylon, modal/nylon, and lyocell/nylon. Useful examples comprise blends of cellulose fiber, e.g., cotton, viscose, or lyocell, and nylon (e.g. Nylon 6,6) at a ratio of 88:12 (cellulose:nylon), or of 50:50 (cellulose:nylon).

Another example of cellulose-containing waste textiles includes blends with Lycra (polyurethane) such as cotton/Lycra, viscose/Lycra, rayon/Lycra, modal/Lycra, and lyocell/Lycra. Useful examples comprise blends of cellulose fiber, e.g., cotton, viscose, or lyocell, and Lycra (polyurethane) at a ratio of 90:10 (cellulose:Lycra) or of 95:5 (cellulose:Lycra).

Additional examples of cellulose-containing waste textiles include acrylic blends such as cotton/acrylic, viscose/acrylic, rayon/acrylic, modal/acrylic, and lyocell/acrylic. Useful examples comprise blends of cellulose fiber, e.g., cotton, viscose, or lyocell, and acrylic at a ratio of 55:45 (cellulose:acrylic), 50:50, 60:40 and 40:60 (cellulose:acrylic).

More specifically, the method of the invention for recovering cellulose from textile comprises the steps of:
Decomposition: treating the cellulose-containing textile with a solvent comprising MSH and acid catalyst to form a reaction mixture in which cellulose fibers are broken down (fibrillated and depolymerized);
Termination by pH adjustment: stopping the cellulose decomposition by adjusting the pH of the reaction mixture (neutralization of the acid);
Precipitation: precipitating the decomposed cellulose from the reaction mixture by diluting the reaction mixture with water;
Recovery: recovering the wet cellulose product from the diluted reaction mixture; and
Processing: processing the wet cellulose to obtain recovered dry cellulose product.

The fibrillation and depolymerization of the cellulose-containing textile by the method of the invention has shown that cellulose is degraded and decomposed from the cellulose matrix, forming micro scale fibrous particles of the crystalline parts of the cellulose. The amorphous parts, naturally occurring 10-30% of the cellulose, are dissolved in the process (Carbohydrate Polymers, Volume 135, 1 Jan. 2016, Pages 1-9).

For reclaiming of both cellulose and synthetic polymer fibers from textiles comprising cellulose/synthetic blends, the method of the invention further comprises the steps of separating the synthetic fibers component, and optionally other non-cellulose materials that may be present in the textile, and recovery of the synthetic fibers. Such that the method of the invention can be described as comprising the steps of:
Decomposition: treating the cellulose-containing textile with a solvent comprising MSH and acid catalyst to form a reaction mixture in which cellulose fibers are broken down (fibrillated and depolymerized);
Termination by pH adjustment: stopping the cellulose decomposition by adjusting the pH of the reaction mixture (neutralization of the acid);
Separation: separating the synthetic fibers component, and optionally other non-cellulose materials that may be present in the textile (such as dyes, dirt, resins, etc.), from the reaction mixture by suitable methods to retain the cellulose dispersed in the liquid phase, such as by decantation or passing through suitable screen;
Precipitation: precipitating the decomposed cellulose from the reaction mixture by diluting the reaction mixture with water;

The order of the previous two steps (separation and precipitation), may be reversed, first precipitating the depolymerized cellulose by diluting the reaction mixture with water, and then separating the synthetic fibers component, and optionally other non-cellulose materials that may be present in the textile, from the diluted liquid phase, followed by recovery of intact synthetic fibers and cellulose, as described in the following steps.
Cellulose Recovery: recovering the wet cellulose product from the diluted reaction mixture;
Synthetic Component Recovery: recovering the synthetic fibers component;
Cellulose Processing: processing the wet cellulose to obtain recovered dry cellulose product; and optionally
Synthetic Component Processing: processing the synthetic fibers to obtain processed recovered synthetic fiber product.

The cellulose-containing waste textiles are preferably cut into pieces by means known in the art, such as, for example, mechanical cutting, shredding, crushing or grinding prior to processing of the textiles utilizing the method of the invention. Piece size may range from 1 mm to 50 mm, more preferably from 2 to 20 mm, most preferably from 5 to 15 mm.

The amounts of the textile that are suitable for loading into the decomposition reaction are typically adjusted to enable effective stirring and flowability of the reaction mixture. In general, practical concentrations of fabric load that enabled effective stirring and flowability are preferably in the range from 1 to 20% by weight, more preferably in the range from 5 to 15% by weight, based on the total reaction mass.

The cellulose decomposition reaction according to the process of the invention produces a cellulose-containing reaction mixture (dispersion). One of the unique features of the method of the invention is that the decomposition reaction is specifically adjusted for fibrillating and depolymerizing the cellulose, degrading the cellulose into a smaller degree of polymerization (DP), while substantially avoiding cellulose degradation into sugars. The cellulose hence undergoes defibrillation into finer fibrils while retaining its molecular structure and can be reused as a micro fiber in various applications. In the case of cellulose-containing waste textiles that are cellulose/polymer blends, the method of the invention is further specifically adjusted for effective separation and recovery of the substantially undamaged synthetic polymer fibers that are suitable for direct reuse in textiles and in other applications.

The dry cellulose product obtained by the method of the invention is preferably Micro Crystalline Cellulose (MCC), also known as cellulose nano fibers (CNF), cellulose nano crystals (CNC), microcellulose or nanocellulose, preferably MCC characterized by a degree of polymerization (DP) of 100-350 repeating units, more preferably by DP of 100-200 repeating units.

The invention advantageously provides a method in which parameters of the cellulose decomposition, such as the type and concentration of the MSH, the type and concentration of the acid catalyst, reaction temperature, reaction time, can be adjusted in order to obtain the desired recycled cellulose product. In the case of cellulose-containing waste textiles that are cellulose/polymer blends, the method of the invention is further specifically adjusted in order to obtain reusable synthetic polymer fibers.

The process of the invention employs MSH as a solvent for cellulose decomposition. In particular, the waste textile is treated with a solvent system that contains at least one MSH, such that the cellulose is soluble/dispersible in the solvent system to form a reaction mixture in which cellulose fibers are decomposed. The concentration of the decomposed cellulose in the reaction mixture is typically in the range of 0.5% to 15% by weight, more preferably from about 5% to 10% by weight, based on the total reaction mass. Process parameters such as waste textile loading, reaction temperature and reaction time, are described in more detail in the examples that follow. The molten salt hydrate (MSH), a key component of the decomposition reaction in the method of the invention, can be recovered and re-used.

Different types of molten salt hydrates (MSHs) can be used in the method of the invention. Especially, MSHs that comprise a cation of alkaline earth metal, for example, calcium (Ca), magnesium (Mg). Particularly preferred are MSHs of calcium (Ca).

Preferably, the MSH is an alkaline earth metal salt wherein the anion in the MSH is at least one selected from the group consisting of halogen or oxoanion. Typically preferred are MSHs having a melting point (M.P.) below room temperature. Among these, more preferred are MSHs in which the anion is halogen, and the halogen is preferably selected from Br or Cl. In general, especially useful are those MSHs in which all cations are hydrated (coordinated) with water molecules, while anions are coordination-free in the system. Especially preferred are MSHs of calcium bromide (CaBr₂) and calcium chloride (CaCl₂), such as for example CaBr₂·4.7H₂O, CaBr₂·8.3H₂O, CaBr₂·9.5H₂O, CaBr₂·12H₂O, CaCl₂·4H₂O, and CaCl₂·6H₂O. Combinations of MSHs, such as for example CaCl₂/MgCl₂, CaBr₂/MgBr₂, CaCl₂/MgBr₂ and CaBr₂/MgCl₂, can also be used.

MSHs, such as for example CaBr₂, CaCl₂), MgBr₂ and MgCl₂, are commercially available on the market from various manufacturers, such as ICL Group Ltd., Rubitherm GmbH, Merck KGAA, Climator Sweden AB, Cristopia Energy Systems, PCM Energy, Mitsubishi Chemical, and EPS Ltd.

Preferably, the MSHs of CaBr₂ are selected from hydrates having a hydrate ratio in the range of 4-11, preferably in the range of 7-9, more preferably of about 7-8.5. Among these, MSH of CaBr₂ having a hydrate ratio of about 8.3 is especially preferred. The melting point of the preferred MSHs of CaBr₂ is typically below room temperature. The amount of the CaBr₂ MSH in the reaction mixture is preferably adjusted in the range of 50-74% by weight based on the total weight of the solution, more preferably to about 57% by weight based on the total weight of the solution. One preferred MSH of CaBr₂ used as a solvent for cellulose dissolution in the method of the invention has a hydrate ratio of about 8.3 and a concentration of about 57% by weight based on the total weight of the reaction mixture.

Preferably, the MSHs of CaCl₂ are selected from hydrates having a hydrate ratio in the range of 4-6, preferably in the range of 5-6, more preferably of about 5 and of about 6. Among these, especially preferred are CaCl₂ 5 hydrate and CaCl₂ 6 hydrate. The melting point of the preferred MSHs of CaCl₂ is typically below room temperature. The concentration of the CaCl₂ MSH in the reaction mixture is preferably adjusted in the range of 50-60% by weight based on the total weight of the solution. Examples of preferred CaCl₂ MSHs used in cellulose decomposition according to the method of the invention are CaCl₂ with a hydrate ratio of about 5 and a concentration of about 55% by weight based on the total weight of the solution and CaCl₂ with a hydrate ratio of about 6 and a concentration of about 50% by weight based on the total weight of the solution.

In accordance with the method of the invention, an acid catalyst is employed in the recovery of cellulose from cellulose-containing textile. Suitable acids can be mineral or organic acids, such as for example HBr, HCl, HNO₃, HClO₄, and more. Such acids are available on the market, e.g., from ICL-IP. Among these, HBr and HCl are especially preferred, in particular HBr (48%) and HCl (32%).

The amount of the acid catalyst is preferably adjusted such that the concentration of the acid is in the range of 0.1-0.5% weight based on MSH weight quantity. For HBr (48%) and MSHs having salt concentration above 55% weight, the preferred concentration of the acid is around 0.25% weight, based on MSH weight quantity. More dilute salt hydrates (MSHs having salt concentration below 50% weight) were found to require higher acid concentrations to obtain similar results.

In general, increased acid concentrations may accelerate fabric decomposition, reduce the final DP of the MCC product and increase the occurrence of by-products (such as for example low molecular weight and oxidized sugars).

The decomposition (fibrillation and depolymerization) of cellulose from cellulose-containing textile in accordance with the method of the invention is typically carried out at a temperature in the range of about 60-120° C. to allow the decomposition (fibrillation and depolymerization) of cellulose. Preferably, the reaction mixture is heated to a temperature of about 80-120° C. during the decomposition step, more preferably to a temperature of about 100-110° C., and most preferably to a temperature of around 105° C. Decomposition temperature above about 120° C. may result in a higher degree of decomposition, by-products formation, and may cause yellowing of the solution, while temperatures below about 60° C. require a longer reaction time.

Time is another important parameter of the cellulose decomposition reaction. Preferably, the reaction is carried out just until all the cellulosic components of the fabric are dispersed in solution. Typical decomposition times are below about 60 minutes, preferably below 30 minutes, more preferably in the range of about 15 to 30 minutes, and even more preferably no longer than about 15 min. An increase in the reaction time may result in higher decomposition and formation of by-products.

To stop the cellulose decomposition reaction, neutralization of the acid to pH˜7 is performed by methods known in the art, such as for example by addition of a neutralizing agent or a buffering agent, such as calcium hydroxide (Ca(OH)₂), CaO/Ca(OH)₂ mixtures, NaOH, NaHCO₃. Alternatively, the method of the invention may be carried out without the addition of a neutralizing agent or a buffering agent. Termination of the cellulose decomposition reaction and neutralization of the reaction mixture can be achieved by diluting the reaction mixture with water.

Therefore one of the advantages of the method of the invention is that the decomposition step is relatively short and does not use aggressive chemicals or conditions. It can thus be conveniently used in an industrial process and have a low carbon footprint.

As a result of the decomposition reaction, the cellulose from the cellulose-containing textile is present as a dissolved/dispersed cellulose in the reaction mixture. Preferably, the reaction mixture contains dissolved/dispersed (fibrillated and depolymerized) cellulose in an amount of around 0.5% to 15% by weight, more preferably in the range of 5% to 10% by weight, based on the total weight of the reaction mixture. Although up to 15% yield can be obtained depending on initial cellulosic fiber concentration in the reaction mass and crystallinity ratio of the cellulose, this range has a sufficient cellulose concentration for efficient and economic MCC production while being sufficiently low for avoiding high viscosities of the mixture that impair the production process.

To improve cellulose decomposition it is also possible to use solubilization enhancers, such as for example chemical, physical, and bio-catalytical agents. Examples of these are oxidizing agents such as bleaches, H₂O₂, and permanganates, acids such as phosphoric acid, oxalic acid, and sulfuric acid, and enzymes such as cellulase. Treatment with solubilization enhancers can be performed before the decomposition step, as a pre-treatment. However, solubilization enhancers can also be added during the decomposition reaction. Also, anti-oxidation agents can be added.

Precipitation of the decomposed cellulose from the reaction mixture may be carried out by diluting the reaction mixture with water, e.g., deionized water. Typically, the amount of water is adjusted such that the weight ratio MSH:water is not less than about 1:1 and can be from about 1:1 to 1:3 (based on the % by weight of the MSH used for the decomposition reaction). Followed by stirring of the mixture for a sufficient time (typically for about 10-60 minutes, usually for about 10-30 minutes) to allow precipitation of the decomposed cellulose from the reaction mixture.

For collecting of both cellulose and synthetic polymer fibers from textile comprising cellulose/synthetic blends, the precipitation step is preceded by separation of the synthetic fibers component, and optionally other non-cellulose materials (such as dyes, dirt, resins, etc.) that may be present in the textile. The synthetic fibers are not affected by the treatment with cellulose-dissolving agents. Therefore, the synthetic fiber component can easily be separated from the diluted reaction mixture (the cellulose-containing liquid phase). For this purpose, physical separation processes such as precipitation, floatation, vacuum or press filtration, phase separation, or centrifugation are particularly suited. The separated cellulose-containing liquid phase is subjected to the next step of recovering the cellulose product. The separated synthetic fibers component can be washed, dried and reused as is, or alternatively, further processed. Non-limiting examples of further processing of the separated synthetic fibers are described in more detail in the examples that follow.

Recovery of the cellulose, e.g., MCC, from the precipitated cellulose may be carried out using different methods known in the art. For example, the precipitated cellulose mixture is filtered and then washed several times with additional water. The resultant wet cellulose is dried, for example at room conditions or under vacuum. The obtained product is reduced to fine particles using one of the conventional technologies, for example using a blade mill, jet mill, hammer mill.

In another aspect, the invention is also directed to production of a cellulosic product, preferably microcrystalline cellulose (MCC), more preferably high-quality MCC, from cellulose-containing waste textile, such as for example cotton-based waste textile or various blended cotton/polymer waste textiles.

The method of the invention is preferably adapted to provide cellulosic fibers, especially MCC, characterized by high aspect ratio, particle size distribution <75 μm, hydrophilicity, mechanical properties, and a degree of polymerization (DP) in the range of about 100 to 350 repeating units. Preferred MCC fibers obtained by the method of the invention are characterized by DP of around 100 to 250 repeating units when tested in accordance with ASTM-D1795-13 standard (“Standard test method for intrinsic viscosity of cellulose”).

In another aspect, the invention is also directed to the recovery of a synthetic fiber, more preferably substantially undamaged reusable synthetic fiber, from various blended cellulose/polymer textiles. The recovered synthetic fiber can be, for example, in a form of a non-woven fabric. The method of the invention is especially adapted for recovery of the polymer fibers in a form that is suitable for direct reuse in textiles and in other applications, e.g., in a form of a non-woven fabric, or respun into yarns using conventional methods for yarn spinning, or used in flocked fabrics.

The recovered synthetic fiber can also be further processed using different methods known in the art. For example, the recovered synthetic fiber can be compressed into solid plastic boards by means known in the art, e.g., by using a compression molding machine. The resultant solid plastic boards can be further processed into pellets by means known in the art, for example by using a shredder. The resultant dried pellets are suitable for feed to an article shaping process, fiber spinning, injection molding, extrusion molding, compression molding, optionally followed by another shaping method. Articles molded from the recovered synthetic fibers form another aspect of the invention.

### BRIEF DESCRIPTION OF THE FIGURES

FIG. 1: photographs of the untreated cotton/PET blend fabric (FIG. 1a), the recovered PET fiber (FIG. 1b), the recovered microcrystalline cellulose (MCC) (FIG. 1c), ×1000 magnification photograph of the untreated cotton/PET blend fabric (FIGS. 1d), and ×1000 magnification photograph of the recovered PET fiber (FIG. 1e), all from Example 15.

FIG. 2: X-ray powder diffraction (XRD) analysis of the recovered microcrystalline cellulose (MCC) product from Example 14 (FIG. 2a) and from Example 15 (FIG. 2b).

FIG. 3: photographs of the untreated cotton/Nylon 6-6 blend fabric (88%/12%) (FIG. 3a), the recovered microcrystalline cellulose (MCC) (FIG. 3b), and the recovered Nylon 6-6 fiber (FIG. 3c), all from Example 19.

FIG. 4: photographs of the untreated cotton/Lycra (polyurethane) blend fabric (90%/10%) (FIG. 4a), the recovered microcrystalline cellulose (MCC) (FIG. 4b), and the recovered Lycra (polyurethane) fiber (FIG. 4c), all from Example 20.

FIG. 5: photographs of the untreated cotton/acrylic (polyacrylate) blend fabric (558/45%) (FIG. 5a), the recovered microcrystalline cellulose (MCC) (FIG. 5b), and the recovered polyacrylate fiber (FIG. 5c), all from Example 21.

FIG. 6: a photograph of the 100% cotton fabric after treatment, from Example 22.

### EXAMPLES

### Materials and Methods

The materials used for regenerating cellulose fibers from textile are tabulated in Table 1.

TABLE 1

| MATERIAL | MANUFACTURER | FUNCTION |
|---|---|---|
| CaBr₂ 4.7 hydrate, | CaBr₂ and CaCl₂ were | concentrated |
| salt concentration | obtained from ICL-IP | salt (MSH) |
| 70% wt | as solid or solution | |
| CaBr₂ 8.3 hydrate, | and diluted to the | concentrated |
| salt concentration | desired concentration | salt (MSH) |
| 57% wt | | |
| CaBr₂ 9.5 hydrate, | | concentrated |
| salt concentration | | salt (MSH) |
| 53.8% wt | | |
| CaBr₂ 12 hydrate, | | concentrated |
| salt concentration | | salt (MSH) |
| 47.5% wt | | |
| CaCl₂ 4 hydrate, | | concentrated |
| salt concentration | | salt (MSH) |
| 60.6% wt | | |
| CaCl₂ 6 hydrate, | | concentrated |
| salt concentration | | salt (MSH) |
| 50.6% wt | | |
| CaCl₂ 6.1 hydrate, | | concentrated |
| salt concentration | | salt (MSH) |
| 50% wt | | |
| LiClO₄ 5 hydrate, | LiClO₄ was obtained | concentrated |
| salt concentration | from Merck as solid | salt (MSH) |
| 54.4% wt | and diluted to the | |
| | desired concentration | |
| CaCl₂/MgCl₂ | CaCl₂/MgCl₂ mixture was | concentrated |
| (1:1.13 mol) 5.6 | obtained from ICL-IP | salt (MSH) |
| hydrate, salt | | |
| concentration | | |
| 50.7% wt | | |
| ZnCl₂ 7.6/6.2 | ZnCl₂ was obtained from | concentrated |
| hydrate, salt | Merck as solid and | salt (MSH) |
| concentration | diluted to the desired | |
| 50/55% wt | concentration | |
| ZnCl₂ 4 hydrate, | | concentrated |
| salt concentration | | salt (MSH) |
| 65% wt | | |
| ZnCl₂ 2.5 hydrate, | | concentrated |
| salt concentration | | salt (MSH) |
| 75% wt | | |
| HBr (48%) | was obtained from ICL-IP | acid catalyst |
| HCl (32%) | was obtained from Merck | acid catalyst |
| CaO/Ca(OH)₂ | was obtained from Merck | neutralizing |
| | | agent |
| 100% Cotton (knit | Commercial fabric was | fabric |
| and woven) | obtained from Global | |
| | Fabric Barkan Israel | |
| Cotton/Polyester | Commercial fabric was | fabric |
| 50%/50% (knit and | obtained from Global | |
| woven) | Fabric Barkan Israel | |
| 100% Polyester | Commercial fabric was | fabric |
| (knit and woven) | obtained from Global | |
| | Fabric Barkan Israel | |
| Cotton/Nylon 6-6 | Commercial fabric was | fabric |
| 88%/12% (knit and | obtained from Global | |
| woven) | Fabric Barkan Israel | |
| Cotton/Lycra | Commercial fabric was | fabric |
| 90%/10% (knit and | obtained from Global | |
| woven) | Fabric Barkan Israel | |
| Cotton/Polyacrylate | Commercial fabric was | fabric |
| 55%/45% knit | obtained from Global | |
| | Fabric Barkan Israel | |

All of the MSH salts were prepared from solid anhydrous or dehydrate salt and diluted in deionized water (DIW) to the desired concentration. For example, CaBr₂·12H₂O was prepared by dissolving 59% weight (wt. %) CaBr₂·2H₂O with 41 wt. % deionized water or by diluting commercial CaBr₂·53 wt. % with 5.7 wt. % deionized water. Dilution/dissolution was also carried out using recycled dilute CaBr₂ solutions obtained from ICL-IP, instead of fresh water. For example, CaCl₂·6H₂O was prepared by concentrating commercial CaCl₂ 30 wt. % solution by removal of 40 wt. % of the water.

### Examples 1-7 (of the Invention)

### 100% Cotton (Knit) Recycling Using Molten Salt Hydrates

A reactor was charged with concentrated molten salt hydrate (MSH) and heated to 105° C. An acid catalyst was added, the reaction mixture was stirred and 100% cotton fabric, preliminarily cut to small pieces, was charged into the reactor at slow stirring. The mixture was stirred for the time required to complete the decomposition of the fabric (decomposition reaction times are provided in Table 2 below). The reaction was quenched with CaO/Ca(OH)₂ mixture (to pH ˜7). The resulting reaction mixture was poured into deionized water and stirred for a few minutes. The diluted mixture of precipitated decomposed cellulose was filtered on a Buchner funnel, washed with fresh deionized water (×3), and dried at normal room conditions to obtain flakes that were milled using a blade mill. The final MCC powder was analyzed in accordance with the ASTM-D1795-13 standard and the DP was recorded.

The reaction parameters are provided in Table 2.

The results are provided in Table 3.

The MSH load percent was calculated based on the weight percentage of salt from the total salt solution.

The acid catalyst (HBr (48%) or HCl (32%)) weight load percent (% wt) was calculated based on the weight percentage of the MSH solution.

The neutralizing agent (CaO/Ca(OH)₂ mixture) weight load percent (% wt) was calculated based on the load percent of the acid added in the process.

The fabric weight load percent (% wt) was calculated based on the weight of the total reaction mixture.

Fabric decomposition ability (qualitative) refers to fabric breakdown and was established by visual observation. With reference to Table 3: “Not fully decomposed” means intact fabric pieces remain in the liquid phase, by visual observation. “Good” means no intact fabric pieces remain in the liquid phase, by visual observation.

Product mixture flowability refers to the attempt to pour the liquid phase. With reference to Table 3: Product mixture flowability “No” means the reaction mixture was difficult to pour. Product mixture flowability “Yes” means the reaction mixture was easily poured.

TABLE 2

| | | MSH | Acid | Fabric | Decomposition | | |
|---|---|---|---|---|---|---|---|
| | MSH | M. P. | Catalyst | load | Reaction | | Fabric |
| Example | (% wt) | (° C.) | (% wt) | (% wt) | time | | blend |
| 1 | CaBr₂ | >100 | HBr (48%) | 10 | 100 | minutes | 100% |
| | 4.7 | | (0.25) | | | | cotton |
| | hydrate | | | | | | |
| | (70) | | | | | | |
| 2 | CaBr₂ | <R.T. | HBr (48%) | 10 | 20 | minutes | 100% |
| | 8.3 | | (0.12) | | | | cotton |
| | hydrate | | | | | | |
| | (57) | | | | | | |
| 3 | CaBr₂ | <R.T. | HBr (48%) | 5 | 20 | minutes | 100% |
| | 9.5 | | (0.5) | | | | cotton |
| | hydrate | | | | | | |
| | (53.8) | | | | | | |
| 4 | CaBr₂ | <R.T. | HBr (48%) | 5 | 20 | minutes | 100% |
| | 12 | | (0.5) | | | | cotton |
| | hydrate | | | | | | |
| | (47.5) | | | | | | |
| 5 | CaCl₂ | <R.T. | HCl (32%) | 10 | 15 | min | 100% |
| | 4 hydrate | | (0.25) | | | | cotton |
| | (60.6) | | | | | | |
| 6 | CaCl₂ | <R.T. | HCl (32%) | 10 | 15 | min | 100% |
| | 6 hydrate | | (0.25) | | | | cotton |
| | (50.6) | | | | | | |
| 7 | CaCl₂/ | >100 | HBr (48%) | 5 | 40 | minutes | 100% |
| | MgCl₂ | | (0.5) | | | | cotton |
| | (1:1.13 | | | | | | |
| | mol) 5.6 | | | | | | |
| | hydrate | | | | | | |
| | (50.7) | | | | | | |

TABLE 3

| | Fabric | | |
|---|---|---|---|
| | decomposition | | |
| | ability | Product mixture | MCC |
| Example | (qualitative) | flowability | DP |
| 1 | Good | No | 118 |
| 2 | Good | Yes | 210 |
| 3 | Not fully decomposed | Yes | 205 |
| 4 | Not fully decomposed | No | 280 |
| 5 | Good | Yes | 209 |
| 6 | Good | Yes | 216 |
| 7 | Good | Yes | 197 |

Examples 3 and 4 show that lower salt concentration (or higher hydrate ratio) have lower decomposition activity. The acid has less influence under these conditions.

The results set out in Table 3 indicate high efficacy of a combination consisting of CaBr₂ 8.3 hydrate (57% wt) for treatment of 100% cotton fabric (Example 2), providing good fabric decomposition and liquid phase flowability, while achieving MCC characterized by DP of 210 units as determined according to ASTM-D1795-13 standard.

### Examples 8-9 (all Comparative)

100% Cotton (Knit) Recycling Using CaCl₂ or LiClO₄ Molten Salt Hydrates without Acid Catalyst

A reactor was charged with concentrated molten salt hydrate (MSH) and heated to 105° C. The reaction mixture was stirred and 100% cotton fabric, preliminarily cut to small pieces, was charged into the reactor at slow stirring. The mixture was stirred for the time required to complete the decomposition of the fabric (decomposition reaction times are provided in Table 4 below). The resulting reaction mixture was poured into deionized water and stirred for a few minutes. The diluted mixture of precipitated decomposed cellulose was filtered on a Buchner funnel, washed with fresh deionized water (×3), and dried at normal room conditions to obtain flakes that were milled using a blade mill. The final MCC powder was analyzed in accordance with the ASTM-D1795-13 standard and the DP was recorded.

The reaction parameters are provided in Table 4.

The results are provided in Table 5.

The MSH load percent was calculated based on the weight percentage of salt from the total salt solution.

The fabric load percent was calculated based on the weight of the total reaction mixture.

Fabric decomposition ability (qualitative) refers to fabric breakdown and was established by visual observation. With reference to Table 5: “Swelled not decomposed” means intact fabric pieces remain in the liquid phase, by visual observation. “Good” means no intact fabric pieces remain in the liquid phase, by visual observation.

Product mixture flowability refers to the attempt to pour the liquid phase. With reference to Table 5: Product mixture flowability “No” means the reaction mixture was difficult to pour. Product mixture flowability “Yes” means the reaction mixture was easily poured.

TABLE 4

| | | MSH | Acid | Fabric | Decomposition | |
|---|---|---|---|---|---|---|
| | MSH | M. P. | Catalyst | load | Reaction | Fabric |
| Example | (% wt) | ( ° C.) | (% wt) | (% wt) | time | blend |
| 8 | CaCl₂ | <R.T. | None | 10 | 2 hours at | 100% |
| | 4 hydrate | | | | 109° C. + | cotton |
| | (60.6) | | | | 5.5 h at | |
| | | | | | 130° C. | |
| 9 | LiClO₄ | <R.T. | None | 5 | 3 hours | 100% |
| | 3 hydrate | | | | | cotton |
| | (66) | | | | | |

TABLE 5

| | Fabric | | |
|---|---|---|---|
| | decomposition | | |
| | ability | Product mixture | MCC |
| Example | (qualitative) | flowability | DP |
| 8 | Good | Yes | 112 |
| 9 | Swelled not decomposed | No | 528 |

The results set out in Tables 4 and 5 indicate that when using CaCl₂ 4 hydrate (60.6% wt), without acid catalyst, for treatment of 100% cotton fabric (Example 8), the decomposition reaction time was prolonged to 7 hours, and higher temperature had to be applied in order to reach good fabric decomposition. In addition, the MCC product was of deep dark color.

When using LiClO₄ 5 hydrate (54.4% wt) without acid catalyst (Example 9) and fabric load of 5% wt, the fabric was swelled and not decomposed after three hours of treatment and the reaction mixture was difficult to pour. The resultant product (after milling) was characterized by a higher degree of polymerization, having a DP of 528 units as determined according to the ASTM-D1795-13 standard. A DP of above 500 is believed to indicate undecomposed cotton material.

### Examples 10-12 (all Comparative)

### 100% Cotton (Knit) Recycling Using Preferred Reaction Conditions and ZnCl₂ Molten Salt Hydrates

A reactor was charged with concentrated molten salt hydrate (MSH) and heated to 105° C. An acid catalyst (HCl (32%)) was added, the reaction mixture was stirred and 100% cotton fabric, preliminarily cut to small pieces, was charged into the reactor at slow stirring. The mixture was stirred for the time required to complete the decomposition of the fabric (decomposition reaction times are provided in Table 6 below). The reaction was quenched with CaO/Ca(OH)₂ mixture (to pH ˜7). The resulting reaction mixture was poured into deionized water and stirred for a few minutes. The diluted mixture of precipitated decomposed cellulose was filtered on a Buchner funnel, washed with fresh deionized water (×3), and dried at normal room conditions to obtain flakes that were milled using a blade mill. The final MCC powder was analyzed in accordance with the ASTM-D1795-13 standard and the DP was recorded.

The reaction parameters are provided in Table 6.

The results are provided in Table 7.

The MSH load percent was calculated based on the weight percentage of salt from the total salt solution.

The acid catalyst (HCl (32%)) weight load percent was calculated based on the weight percentage of the MSH solution.

The neutralizing agent (CaO/Ca(OH)₂ mixture) load percent was calculated based on the load percent of the acid added in the process.

The fabric load percent was calculated based on the weight of the total reaction mixture.

Fabric decomposition ability (qualitative) refers to fabric breakdown and was established by visual observation.

Product mixture flowability refers to the attempt to pour the liquid phase.

TABLE 6

| | | MSH | Acid | Fabric | Decomposition | |
|---|---|---|---|---|---|---|
| | MSH | M.P. | Catalyst | load | Reaction | Fabric |
| Example | (% wt) | ( ° C.) | (% wt) | (% wt) | time | blend |
| 10 | ZnCl₂ | <R.T. | HCl (32%) | 10 | 15 min | 100% |
| | 7.6/6.2 | | (0.2) | | | cotton |
| | hydrate | | | | | |
| | (50/55) | | | | | |
| 11 | ZnCl₂ | <R.T. | HCl (32%) | 10 | 15 min | 100% |
| | 4 hydrate | | (0.2) | | | cotton |
| | (65) | | | | | |
| 12 | ZnCl₂ | <R.T. | HCl (32%) | 10 | 15 min | 100% |
| | 2.5 | | (0.2) | | | cotton |
| | hydrate | | | | | |
| | (75) | | | | | |

TABLE 7

| | Fabric | | | |
|---|---|---|---|---|
| | decomposition | | | |
| | ability | Product mixture | MCC | MCC product |
| Example | (qualitative) | flowability | DP | appearance |
| 10 | Poor to no | No | 811/639 | Upon milling - |
| | decomposition | | | decomposition |
| | | | | to sieves |
| | | | | instead of |
| | | | | powder |
| 11 | Swelling and | No | 268 | Upon milling - |
| | partial | | | Intermediate |
| | decomposition | | | between sieves |
| | | | | and powder |
| 12 | Good | No | 120 | Greyish color |
| | decomposition | Very viscous | | After drying - |
| | | mass | | hard material |

With reference to Table 7:

Product mixture flowability “No” means the reaction mixture was difficult to pour.

“Upon milling” refers to milling of the MCC product using a blade mill.

“Greyish color” was observed by visual observation and refers to both the reaction mixture and the MCC product. The reaction mixture was gray and the dried product was dark gray pellets. The normal color is white to off-white. When drastic conditions were applied (particularly longer heating time) darker colors appear, yellowish to brown. The longer the heating time, the darker the developed color.

“After drying—hard material”, refers to the MCC product as the wet cake dried. Normal state is soft agglomerates/flakes, crumbling under hand touch.

### Examples 13-15 (of the Invention)

Treatment of Cotton/Polyester Blend Fabric (50/50 wt. %) Using Preferred Reaction Conditions and CaCl₂ or CaBr₂ Molten Salt Hydrate

A reactor was charged with concentrated CaBr₂ or CaCl₂ and heated to 105° C. HBr 48% (0.2-0.6 wt. % of the amount of CaBr₂) or HCl 32% (0.2 wt. % of the amount of CaCl₂)) was added, the reaction mixture was stirred and 50%/50% cotton polyester blend fabric that was previously cut into medium size pieces (10-12 wt. % of a total batch) was charged into the reactor at slow stirring. The mixture was stirred for 20-30 minutes at 105° C. to complete the decomposition of the fabric. A stoichiometric quantity of CaO/Ca(OH)₂ mixture was added to pH ˜7. The reaction mixture was poured into deionized water and stirred for a few minutes. The diluted mixture of precipitated decomposed cellulose and the intact polyester fabric was first separated on a rough sieve, after which the liquid dispersion was filtered on a Buchner funnel, washed with fresh deionized water (×3), and dried at room conditions to obtain flakes that were milled using a blade mill. The DP of the resulting MCC powder was determined according to the ASTM-D1795-13 standard. The polyester pieces were washed with deionized water and dried. The yield of polyester was quantitative.

The reaction parameters are provided in Table 8.

The results are provided in Table 9.

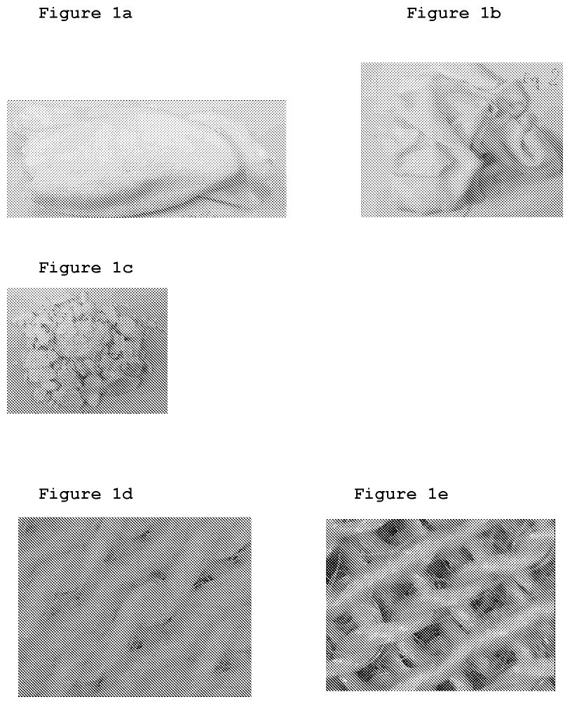

Photographs of the untreated cotton/PET blend, the recovered PET and the recovered MCC, all from Example 15, are shown in FIG. 1a, 1b and 1c, respectively.

×1000 magnification photographs of the untreated cotton/PET blend fabric and the recovered PET fiber, all from Example 15, are shown in FIGS. 1d and 1e, respectively.

The MSH load percent was calculated based on the weight percentage of salt from the total salt solution.

The fabric load percent was calculated based on the weight of the total reaction mixture.

TABLE 8

| | | MSH | Acid | Fabric | | |
|---|---|---|---|---|---|---|
| | MSH | M. P. | Catalyst | load | Reaction | Fabric |
| Example | (% wt) | ( ° C.) | (% wt) | (% wt) | time | blend |
| 13 | CaCl₂ | <R.T. | HCl (32%) | 10 | 20 minutes | 50% |
| | 6.1 | | (0.2) | | | cotton/50% |
| | hydrate | | | | | polyester |
| | (50) | | | | | |
| 14 | CaCl₂ | <R.T. | HCl (32%) | 10 | 20 minutes | 50% |
| | 5 hydrate | | (0.2) | | | cotton/50% |
| | (55) | | | | | polyester |
| 15 | CaBr₂ 8.3 | <RT | HBr (48%) | 10-12 | 20-30 | 50% |
| | hydrate | | (0.2-0.6) | | | cotton/50% |
| | (57) | | | | | polyester |

TABLE 9

| | Fabric | | | |
|---|---|---|---|---|
| | decomposition | | | |
| | ability | MCC | MCC | Polyester |
| Example | (qualitative) | yield | DP | yield |
| 13 | Good | 76% | 207 | Quantitative |
| 14 | Good | 76% | 174 | Quantitative |
| 15 | Good | 60% | 224 | Quantitative |

With reference to Table 9:

Quantitative means full recovery. The polyester remained intact.

### Example 16 (Comparative)

### Treatment of Cotton/Polyester Blend Fabric (50/50 wt. %) Using Preferred Reaction Conditions and ZnCl₂ Molten Salt Hydrate

A reactor was charged with concentrated ZnCl₂ (4 hydrate, 65 wt. %) and heated to 105° C. HCl 32% (0.2 wt. % of the amount of ZnCl₂) was added, the reaction mixture was stirred and 50%/50% cotton polyester blend fabric that was previously cut into medium size pieces (10 wt. % of a total batch) was charged into the reactor at slow stirring. The mixture was stirred for 20 minutes at 105° C. to complete the decomposition of the cellulose in the fabric. The reaction mixture was poured into deionized water and stirred for a few minutes. The diluted mixture of precipitated decomposed cellulose and the intact polyester fabric was first separated on a rough sieve, after which time the liquid dispersion was filtered on a Buchner funnel, washed with fresh deionized water (×3), and dried at room conditions to obtain flakes that were milled using a blade mill.

### Results:

The ratio of removed cotton was 178 by weight of the cotton part, i.e. of 50%, compared to 85% with CaCl₂; or 90-100% with CaBr₂ (Examples 13-15 above). The yield of MCC obtained was 9% by weight (of the cotton part, i.e. 50%), compared to 76% with CaCl₂); or 60% with CaBr₂ (Examples 13-15 above). DP of the resulting MCC powder was 170 units as determined according to the ASTM-D1795-13 standard.

In this experiment most of the cotton was not removed from the fabric and the polyester was not fully separated.

### Example 17 (of the Invention)

Processing of Reclaimed Polyester Recovered from Treatment of Cotton/Polyester Blend Fabric (50/50 wt. %)

Polyester fabric pieces recovered from the treatment of cotton/polyester blend fabric (50/50 wt. %) in Example 15 were converted into plastic pellets by the following procedure: The polyester fabric pieces were compressed by a compression molding machine (Lab-Tech, Model LP-S-50) at 260° C. for 3 minutes, forming a solid plate. The plate was cut into small flakes using a shredder (Yann Bang, Model YBCS-2-H).

The flakes were processed into standard bars using Arburg 320S 500-150 Injection moulding machine.

Untreated 100% polyester fabric that was obtained from Global Fabric Barkan Israel was used for comparison.

Results of mechanical properties tests are provided in Table 10.

TABLE 10

| 100% Polyester | Treated Polyester |
|---|---|
| fabric | fabric |
| #1 | #2 |

Three points bending flexural test

| | | | |
|---|---|---|---|
| Max. stress | MPa | 83.4 | 69.0 |
| SD | | 8.21 | 0.35 |
| Max. strain | % | 2.92 | 2.35 |
| SD | | 0.39 | 0.35 |
| Modulus | MPa | 2703 | 2778 |
| SD | | 71.0 | 87.0 |

Reverse notched Impact strength

| | | | |
|---|---|---|---|
| Reverse notched | J/m | 113.0 | 83.4 |
| Izod | | | |
| SD | | 28.3 | 9.6 |

According to the results, the untreated 100% polyester fabric (test sample #1) has slightly higher tensile strength and impact resistance compared to the recovered polyester fabric (test sample #2).

### Example 18

XRD Analysis of MCC Product from Examples 14 and 15

Phase analysis of the sample was performed by the X-ray powder diffraction (XRPD) method. The data were collected on a Panalytical Empyrean powder diffractometer (K_{α} radiation, λ=1.541 \acute{Å}) equipped with an X'Celerator linear detector and operated at v=40 kV, I=30 mA. Data were collected between 5-45° 2θ. Phase analysis was performed using the Match! phase identification software version 2.1.1 in conjunction with the International Center for Diffraction Data (ICDD) Powder Diffraction File (PDF-4) database (2022 release). Identified phases are listed in Table 11.

Percent crystallinity of the identified cellulose (I) phase was calculated using the equation (Das et al., 2010), as presented in (Pachua et al., 2014):

$$Crystallinity Index ( \% ) = \frac{{I}_{002} - {I}_{am}}{{I}_{002}} \times 100$$

Where I₀₀₂ is the (integrated) peak intensity of (002) cellulose peak (2θ˜22°), representing the crystalline portion of the cellulose; and Iₐₘ is the (integrated) intensity of the broad peak (hump) at 2θ ˜18°, representing the amorphous portion of the cellulose.

The crystallinity index of each sample is also listed in Table 11.

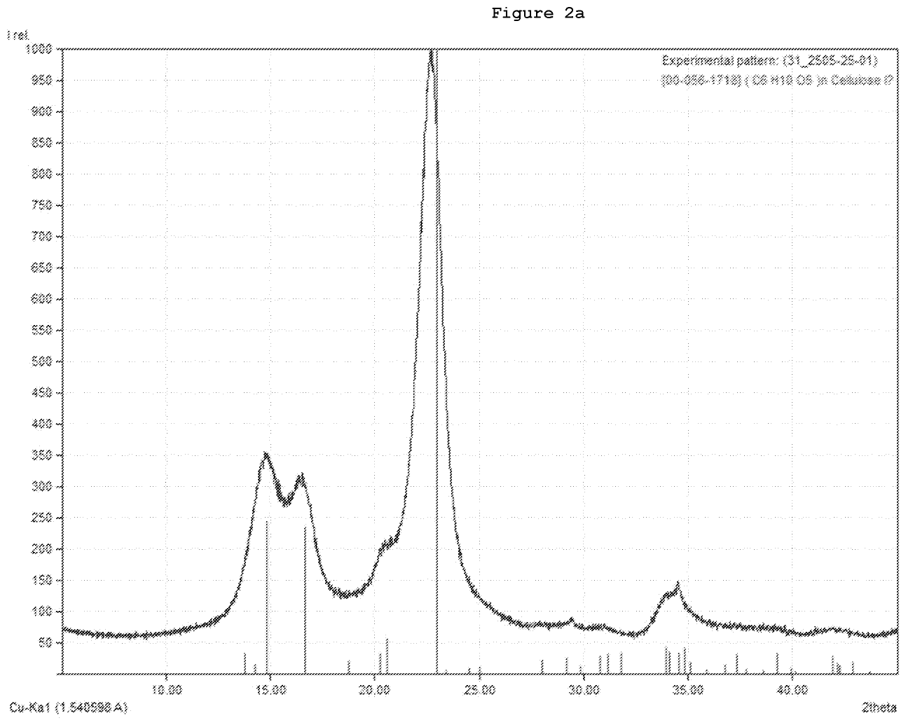

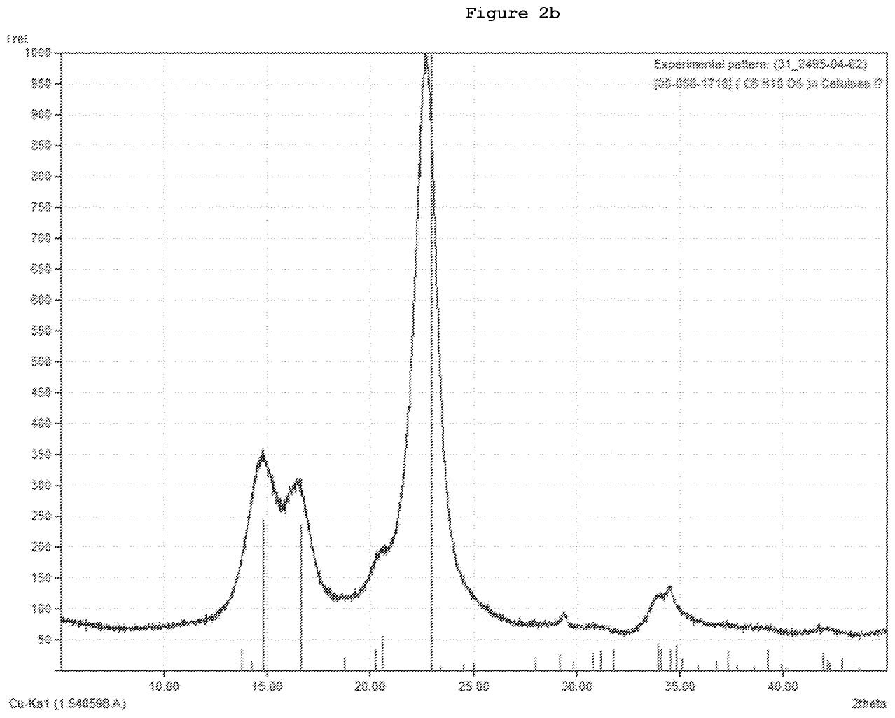

XRD phase diffraction patterns are shown in FIG. 2.

TABLE 11

| | | | Crystallinity |
|---|---|---|---|
| Sample | Major Phases (s) | Minor Phase (s) | Index (%) |
| 2505-25-01 | Cellulose I | None identified | 75.98 |
| | ((C₆H₁₀O₅)ₙ) | | |
| 2495-04-02 | Cellulose I | None identified | 76.24 |
| | ((C₆H₁₀O₅)ₙ) | | |

With reference to Table 11 and FIG. 2:

Sample 2505-25-01 was a sample of the MCC product obtained in Example 14 above. The XRD phase diffraction pattern is shown in FIG. 2a.

Sample 2495-01-02 was a sample of the MCC product obtained in Example 15 above. The XRD phase diffraction pattern is shown in FIG. 2b.

### Examples 19-21 (of the Invention)

### Treatment of Cotton/Nylon 6-6 Blend Fabric (88/12 wt. %), Cotton/Lycra (Polyurethane) Blend Fabric (90/10 wt. %) and Cotton/Acrylic Blend Fabric (55/45 wt. %)

A reactor was charged with concentrated CaCl₂*6H2O (50 weight % (wt. %)) and heated to reaction temperature (see Table 12). HCl 32% (0.13 wt. % of the amount of CaCl₂) was added, the reaction mixture was stirred and the cotton/synthetic fiber blend fabric (3-4 wt. % of a total batch) that was previously cut into medium size pieces was charged into the reactor at slow stirring. The mixture was stirred and heated at reaction temperature (see Table 12) to complete the decomposition of the fabric. The reaction mixture was withdrawn from the reactor and diluted with deionized water (1:3 mixture to water by weight). The synthetic fiber was separated on a 1 mm sieve, after which the liquid dispersion of precipitated decomposed cellulose (micro crystalline cellulose (MCC) fraction) was filtered on a Buchner funnel. The filtrate was used as medium for manual rubbing of the synthetic fiber to remove MCC trapped in the polymer matrix. Manual rubbing was repeated in clean water until no more cloudiness was observed.

The cellulose (MCC) fractions were combined, washed with clean deionized water (DIW), dried under vacuum at 80-100° C. and milled using a blade mill. The degree of polymerization (DP) of the resulting MCC powder was determined according to the ASTM-D1795-13 standard.

The reaction parameters are provided in Table 12.

The results are provided in Table 13.

TABLE 12

| | | Acid | Fabric | | | |
|---|---|---|---|---|---|---|
| | MSH | Catalyst | load | Reaction | Reaction | |
| | (weight %/ | (weight %/ | (weight %/ | temperature | time | Fabric |
| Example | weight g) | weight g) | weight g) | (° C.) | (minutes) | blend |
| 19 | CaCl₂ | HCl (32%) | 3%/ | 105 | 26 | Cotton 88%/ |
| | 6 hydrate | (0.13%/ | 18.5 g | | | Nylon 6-6 |
| | (50%/ | 0.78 g) | | | | 12% |
| | 598 g) | | | | | |
| 20 | CaCl₂ | HCl (32%) | 3%/ | 105-106 | 30 | Cotton 90%/ |
| | 6 hydrate | (0.13/ | 18.5 g | | | Lycra 10% |
| | (50%/ | 0.78 g) | | | | |
| | 598 g) | | | | | |
| 21 | CaCl₂ | HCl (32%) | 4%/ | 107 | 30 | Cotton 55%/ |
| | 6 hydrate | (0.13/ | 20.9 g | | | Polyacrylate |
| | (50%/ | 0.78 g) | | | | 45% |
| | 598 g) | | | | | |

With reference to Table 12:

The molten salt hydrate (MSH) load percent was calculated based on the weight percentage of salt from the total salt solution. The fabric load percent was calculated based on the weight of the total reaction mixture.

TABLE 13

| | Recovered | Recovered | | |
|---|---|---|---|---|
| | synthetic | cellulose | | |
| | fiber (yield | (MCC) (yield | MCC | Assessment |
| Example | %/weight g) | %/weight g) | DP | (qualitative) |
| 19 | 88%/1.95 g | 90%/14.6 g | 208 | Visually good |
| | | | | separation |
| 20 | 63%/1.16 g | 84%/14.0 g | 108 | Some of the fine |
| | | | | Lycra fibers were |
| | | | | collected together |
| | | | | with the recovered |
| | | | | cellulose (MCC). |
| 21 | 107%/10.1 g | 82%/9.4 g | 208 | Some of the |
| | | | | decomposed |
| | | | | cellulose remained |
| | | | | trapped within the |
| | | | | acrylic matrix |
| | | | | after work-up |

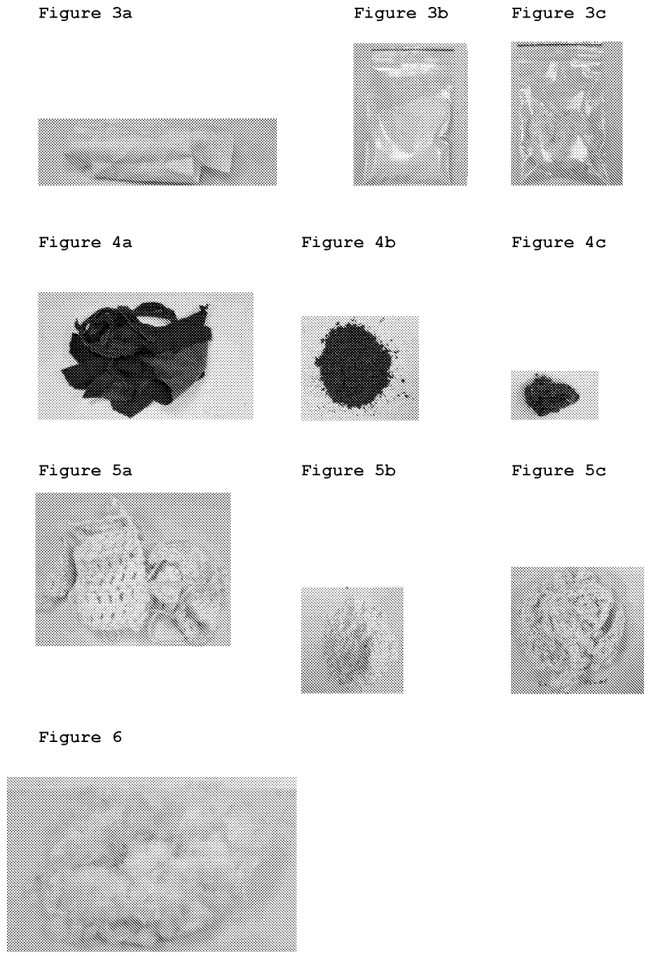

Photographs of the untreated cotton/Nylon 6-6 blend fabric (88%/12%), the recovered MCC and the recovered Nylon 6-6, all from Example 19, are shown in FIGS. 3a, 3b and 3c, respectively.

Photographs of the untreated cotton/Lycra (polyurethane) blend fabric (90%/10%), the recovered MCC and the recovered Lycra (polyurethane), all from Example 20, are shown in FIGS. 4a, 4b and 4c, respectively.

Photographs of the untreated Cotton/Acrylic (polyacrylate) blend fabric (55%/45%), the recovered MCC and the recovered polyacrylate, all from Example 21, are shown in FIGS. 5a, 5b and 5c, respectively.

### Examples 22-26 (all Comparative)

### Treatment of 100% Cotton Fabric and of Cotton/Polyester Blend Fabric (50/50 wt. %), Using ZnCl₂ Molten Salt Hydrate

Examples 22-26 were carried out with fabric load of 2.4 weight percent (% wt). The fabric load percent was calculated based on the weight of the total reaction mixture.

The degree of polymerization (DP) of the initial (before treatment) 100% cotton fabric (Examples 22-23) was approximately 3000.

The degree of polymerization (DP) of cotton in the Cotton/polyester (PET) blend fabric (Examples 24-26) was not measured.

The degree of polymerization (DP) DP of the recovered cellulose product was determined according to the ASTM-D1795-13 standard.

All of the experiments (Examples 22-26) were carried out using ZnCl₂*4H₂O, 65 weight % (wt. %) concentration. Zinc chloride solid anhydrous was diluted with deionized water (DIW) to the desired concentration (and analyzed for verification).

Example 22: A reactor was charged with concentrated ZnCl₂*4H₂O (65 weight % (wt. %), 255.8 g) and heated to first (1st) reaction temperature (see Table 14). The reaction mixture was stirred and the 100% cotton fabric (6.3 g) that was previously cut into small size pieces was added to the heated solution. The reaction mixture was stirred and heated at 1^{st} reaction temperature for first (1^{st}) reaction time (see Table 14), after which time the temperature was raised to second (2^{nd}) reaction temperature and stirring continued for second (2^{nd}) reaction time (see Table 14). The heating was discontinued and deionized water (DIW) (76.4 g) was added with stirring. The liquid was withdrawn through the bottom valve and the fabric, which didn't flow, was picked up from above. The cotton fabric pieces were washed on a Büchner funnel with plenty of clean DIW, dried (vacuum, 85° C.) and milled using a blade mill. The obtained product was in a form of fibers, a behavior more typical of cotton fabric before dissolution, unlike decomposed cellulose (MCC). The DP of the product was measured and recorded (see Table 15).

Example 23: A reactor was charged with concentrated ZnCl₂*4H₂O (65 weight % (wt. %), 255.8 g) and heated to reaction temperature (see Table 14). The reaction mixture was stirred and the 100% cotton fabric (6.3 g) that was previously cut into small size pieces was added to the heated solution. The reaction mixture was stirred and heated at reaction temperature for reaction time (see Table 14). The heating was discontinued and deionized water (DIW) (76.4 g) was added with stirring. The liquid was withdrawn through the bottom valve and the fabric, which didn't flow, was picked up from above. The cotton fabric pieces were washed on a Büchner funnel with plenty of clean DIW, dried (vacuum, 85° C.) and milled using a blade mill. The obtained product was in a form of fibers, a behavior more typical of cotton fabric before dissolution, unlike decomposed cellulose (MCC). The DP of the product was measured and recorded (see Table 15).

Example 24: A reactor was charged with concentrated ZnCl₂*4H₂O (65 weight % (wt. %), 255.8 g) and heated to first (1st) reaction temperature (see Table 14). The reaction mixture was stirred and the cotton/PET fabric (6.3 g) that was previously cut into small size pieces was added to the heated solution. The reaction mixture was stirred and heated at 1^{st} reaction temperature for first (1^{st}) reaction time (see Table 14), after which time the temperature was raised to second (2^{nd}) reaction temperature and stirring continued for second (2^{nd}) reaction time (see Table 14). The heating was discontinued and deionized water (DIW) (76.4 g) was added with stirring. The liquid was withdrawn through the bottom valve and the fabric was picked up from above. The fabric pieces were subjected to manual rubbing in clean DIW to remove decomposed cellulose potentially trapped in the fabric. The water was clear. The fabric pieces were filtered and washed on a Büchner funnel with plenty of clean DIW and dried (vacuum, 85° C.). Cellulose was not separated from the PET (the obtained fabric pieces weighted 6.2 g, see Table 15).

Example 25: A reactor was charged with concentrated ZnCl₂*4H₂O (65 weight % (wt. %), 255.8 g) and heated to reaction temperature (see Table 14). The reaction mixture was stirred and the cotton/PET fabric (6.3 g) that was previously cut into small size pieces was added to the heated solution. The reaction mixture was stirred and heated at reaction temperature for reaction time (see Table 14). The heating was discontinued and deionized water (DIW) (76.4 g) was added with stirring. The liquid was withdrawn through the bottom valve and the fabric was picked up from above. The liquid fraction was clear. The fabric pieces were subjected to manual rubbing in clean DIW to remove decomposed cellulose potentially trapped in the fabric. After combining the liquid from the reaction and water from manual rubbing the cloudy aqueous mixture was filtered on a Büchner funnel and the cellulose fraction washed and dried (vacuum, 85° C.). The weights of the isolated fabric after drying and of the isolated cellulose fraction, and the DP of the isolated cellulose fraction, were measured (see Table 15).

Example 26: A reactor was charged with concentrated ZnCl₂*4H₂O (65 weight % (wt. %), 255.8 g) and heated to reaction temperature (see Table 14). HCl (32%, 0.32 g) was added, the reaction mixture was stirred and the cotton/PET fabric (6.3 g) that was previously cut into small size pieces was added to the heated solution. The reaction mixture was stirred and heated at reaction temperature for reaction time (see Table 14). The heating was discontinued and deionized water (DIW) (76.4 g) was added with stirring. The liquid (slightly cloudy) was withdrawn through the bottom valve and the fabric was picked up from above. The fabric pieces were subjected to manual rubbing in clean DIW to remove decomposed cellulose potentially trapped in the fabric. After combining the liquid from the reaction and water from manual rubbing the cloudy aqueous mixture was filtered on a Buchner funnel and the cellulose fraction washed and dried (vacuum, 85° C.). The weights of the isolated fabric after drying and of the isolated cellulose fraction, and the DP of the isolated cellulose fraction, were measured (see Table 15).

The reaction parameters for Examples 22-26 are provided in Table 14.

The results for Examples 22-26 are provided in Table 15.

A photograph of the 100 Cotton fabric after treatment, from Example 22, is shown in FIG. 6.

TABLE 14

| | | | | Fabric | Reaction |
|---|---|---|---|---|---|
| | Treated | MSH | HCl | load | temperature |
| | Fabric | (weight %/ | (32%) | (weight %/ | (° C.)/Reaction |
| Example | type | weight g) | weight g) | weight g) | time (minutes) |
| 22 | Cotton | ZnCl₂ | absent | 2.4%/6.3 g | 65° C./20 min + |
| | 100% | 4 hydrate | | | 70° C./30 min |
| | | (65%, 255.8 g) | | | |
| 23 | Cotton | ZnCl₂ | absent | 2.4%/6.3 g | 80° C./60 min |
| | 100% | 4 hydrate | | | |
| | | (65%, 255.8 g) | | | |
| 24 | Cotton 50%/ | ZnCl₂ | absent | 2.4%/6.3 g | 65° C./20 min + |
| | Polyester | 4 hydrate | | | 70° C./30 min |
| | (PET) 50% | (65%, 255.8 g) | | | |
| 25 | Cotton 50%/ | ZnCl₂ | absent | 2.4%/6.3 g | 80° C./60 min |
| | Polyester | 4 hydrate | | | |
| | (PET) 50% | (65%, 255.8 g) | | | |
| 26 | Cotton 50%/ | ZnCl₂ | HCl | 2.4%/6.3 g | 105° C./20 min |
| | Polyester | 4 hydrate | (32%) | | |
| | (PET) 50% | (65%, 255.8 g) | (0.13%/0.78 g) | | |

TABLE 15

| | Recovered non- | Recovered | |
|---|---|---|---|
| | cellulose part | cellulose part | DP of |
| | (weight | (weight | recovered |
| Example | g/% yield) | g/% yield) | cellulose |
| 22 | — | 6.22/99 | 1227 |
| 23 | — | 5.9/94 | 821 |
| 24 | 6.2/197 | — | — |
| 25 | 6.02/191 | 0.27/8.6 | 365 |
| 26 | 5.0/159 | 0.85/27 | 131 |

With reference to Table 15, Examples 22-23: DP values of about 800-1200 are typical for non-decomposed cellulose.

1) A method for reclaiming fibers from a textile made of cellulose/synthetic fiber blend, comprising adding the textile to a solution comprising molten salt hydrate (MSH) and an acid catalyst to form a reaction mixture in which cellulose fibers are fibrillated and depolymerized, terminating the reaction to obtain fibrillated and depolymerized cellulose, recovering the cellulose from the reaction mixture, and recovering the synthetic fiber.

2) The method according to claim 1, wherein the acid is selected from hydrobromic acid (HBr) and hydrochloric acid (HCl).

3) The method according to claim 1, wherein the molten salt hydrate is selected from calcium and magnesium halide salts and mixtures thereof.

4) The method according to claim 3, wherein the molten salt hydrate is selected from calcium bromide (CaBr₂), calcium chloride (CaCl₂), magnesium bromide (MgBr₂), magnesium chloride (MgCl₂) and mixtures thereof.

5) The method according to claim 4, wherein the molten salt hydrate is selected from calcium bromide (CaBr₂) and calcium chloride (CaCl₂).

6) The method according to claim 5, wherein the molten salt hydrate is selected from CaBr₂ with a hydrate ratio in the range of 4-11 and CaCl₂ with a hydrate ratio in the range of 4-6.

7) The method according to claim 6, wherein the molten salt hydrate is selected from CaBr₂ with a hydrate ratio in the range of 7-9 and calcium chloride with a hydrate ratio in the range of 5-6.

8) The method according to claim 1, wherein the reaction mixture is heated to a temperature of about 60-120° C.

9) The method according to claim 1, wherein the reaction is terminated by adjusting the pH of the reaction mixture to obtain the fibrillated and depolymerized cellulose dispersed in the reaction mixture.

10) The method according to claim 1, wherein the fibrillated and depolymerized cellulose is recovered by diluting the reaction mixture with water to obtain the cellulose in a form separable from a liquid phase of the diluted reaction mixture, removing the synthetic fiber and separating the cellulose product from the diluted reaction mixture.

11) The method according to claim 1, wherein the cellulose in the cellulose/synthetic fiber blend is a natural plant-based fiber or a man-made cellulosic fiber selected from cotton, hemp, sisal, flax, jute, ramie, bagasse, and a mixture thereof; or regenerated cellulose, viscose, rayon, cupro, lyocell, modal and a mixture thereof.

12) The method according to claim 11, wherein the natural plant-based fiber in the cellulose/synthetic fiber blend is cotton.

13) The method according to claim 1, wherein the synthetic fiber in the textile made of cellulose/synthetic fiber blend is selected from polyethylene terephthalate (polyester), polybutylene terephthalate (PBT), polylactic acid (PLA), polyolefins, polyamides, polyurethane (Lycra) and polyacrylonitrile (Acrylic).

14) The method according to claim 12, wherein the synthetic fiber in the cellulose/synthetic fiber blend is selected from polyethylene terephthalate (polyester), polyamides (nylon), polyurethane (Lycra) and polyacrylonitrile (Acrylic).

15) The method according to claim 1, wherein the synthetic fiber is recovered substantially undamaged.

16) The method according to claim 1, wherein the cellulose product is recovered in a form of a micro crystalline cellulose (MCC).

17) The method according to claim 16, wherein the micro crystalline cellulose is characterized by a degree of polymerization (DP) of 100-350 repeating units, preferably of 100-250 repeating units.

18) The method according to claim 1, comprising the steps of:
Decomposition: adding the textile to a solution comprising molten salt hydrate and an acid catalyst to form a reaction mixture in which cellulose fibers are fibrillated and depolymerized;
Termination by pH adjustment: stopping the cellulose decomposition by adjusting the pH of the reaction mixture;
Separation: separating the synthetic fibers, and optionally other non-cellulose materials that may be present in the textile, from the reaction mixture and retaining the cellulose dispersed in the liquid phase;
Precipitation: precipitating the decomposed cellulose from the reaction mixture by diluting the reaction mixture with water; and
Cellulose Recovery: separating the wet cellulose product from the diluted reaction mixture.

19) The method according to claim 18, wherein the order of the separation and precipitation steps is reversed, first precipitating the depolymerized cellulose by diluting the reaction mixture with water, and then separating the synthetic fiber, and optionally other non-cellulose materials that may be present in the textile, from the diluted liquid phase.

20) The method according to claim 1, wherein the amount of the acid catalyst is adjusted in the range of about 0.1-0.5% weight based on molten salt hydrate weight quantity.

21) A method for reclaiming cellulose from a textile made of cellulose fiber, comprising adding the textile to a solution comprising molten salt hydrate and an acid catalyst to form a reaction mixture in which cellulose fibers are fibrillated and depolymerized, terminating the reaction to obtain fibrillated and depolymerized cellulose, recovering the cellulose from the reaction mixture.

22) The method according to claim 21, wherein the acid is selected from hydrobromic acid (HBr) and hydrochloric acid (HCl).

23) The method according to claim 21, wherein the molten salt hydrate is selected from calcium and magnesium halide salts and mixtures thereof.

24) The method according to claim 23, wherein the molten salt hydrate is selected from calcium bromide (CaBr₂), calcium chloride (CaCl₂), magnesium bromide (MgBr₂), magnesium chloride (MgCl₂) and mixtures thereof.

25) The method according to claim 24, wherein the molten salt hydrate is selected from calcium bromide (CaBr₂) and calcium chloride (CaCl₂).

26) The method according to claim 25, wherein the molten salt hydrate is selected from CaBr₂ with a hydrate ratio in the range of 4-11 and CaCl₂ with a hydrate ratio in the range of 4-6.

27) The method according to claim 26, wherein the molten salt hydrate is selected from CaBr₂ with a hydrate ratio in the range of 7-9 and calcium chloride with a hydrate ratio in the range of 5-6.

28) The method according to claim 21, wherein the reaction mixture is heated to a temperature of about 60-120° C.

29) The method according to claim 21, wherein the reaction is terminated by adjusting the pH of the reaction mixture to obtain the fibrillated and depolymerized cellulose dispersed in the reaction mixture.

30) The method according to claim 21, wherein the fibrillated and depolymerized cellulose is recovered by diluting the reaction mixture with water to obtain the cellulose in a form separable from a liquid phase of the diluted reaction mixture.

31) The method according to claim 21, wherein the cellulose fiber is a natural plant-based fiber or a man-made fiber selected from cotton, hemp, sisal, flax, jute, ramie, bagasse, and a mixture thereof; or regenerated cellulose, viscose, rayon, cupro, lyocell, modal and a mixture thereof.

32) The method according to claim 31, wherein the natural plant-based fiber is cotton.

33) The method according to claim 21, wherein the cellulose product is recovered in a form of a micro crystalline cellulose (MCC).

34) The method of claim 33, wherein the micro crystalline cellulose is characterized by a degree of polymerization (DP) of 100-350 repeating units, more preferably of 100-250 repeating units.

35) The method according to claim 21, comprising the steps of:
Decomposition: adding the textile to a solution comprising molten salt hydrate and an acid catalyst to form a reaction mixture in which cellulose fibers are fibrillated and depolymerized;
Termination by pH adjustment: stopping the cellulose decomposition by adjusting the pH of the reaction mixture;
Precipitation: precipitating the decomposed cellulose from the reaction mixture by diluting the reaction mixture with water;
Cellulose Recovery: recovering the wet cellulose product from the diluted reaction mixture; and
Processing: processing the wet cellulose to obtain recovered dry cellulose product.

36) The method according to claim 21, wherein the amount of the acid catalyst is adjusted in the range of about 0.1-0.5% weight based on molten salt hydrate weight quantity.
